(19) United States
(12) Patent Application Publication
(10) Pub. No.: US 2012/0188841 A1
(43) Pub. Date: Jul. 26, 2012

(54) Hermetic Blender

(76) Inventor: Warren Shawn BYRNE, San Marcos, CA (US)

(21) Appl. No.: 13/352,183

(22) Filed: Jan. 17, 2012

Related U.S. Application Data
(60) Provisional application No. 61/434,996, filed on Jan. 21, 2011.

(51) Int. Cl. B01F 7/16; B01F 15/00

(52) U.S. Cl. 366/142

(57) ABSTRACT

A hermetic blender comprises a hermetic blender station, a base platform, a cup, and a holder. The hermetic blender station is connected to the base platform. The cup is inserted into the holder and the holder is attached to the hermetic blender station. The cup is sealed into a cup seal which is positioned in the hermetic blender station. A blade which is positioned inside the hermetic blender station mixes the ingredients which are filled inside the cup. Because of the air tight seal between the cup seal and the cup, and the unique movement of the blade, the hermetic blender is capable of mixing different viscosity products without introducing air into the product.

The current application claims a priority to the U.S. Provisional Patent application Ser. No. 61/434,996 filed on Jan. 21, 2011.

### FIELD OF THE INVENTION

The present invention relates generally to food processing appliances. Specifically, the present invention relates to an industrial blender which blends many different products into a specific volume.

### BACKGROUND OF THE INVENTION

Most of the traditional blenders have a rotating blade positioned in the bottom of a mixing container. When ingredients are mixed together, the ingredients fall back into the blade because of the gravity effect. In order to create this process, the viscosity of the product is lowered by adding liquid into a mixture. Just by adding liquid into the mixture, the flavor is diluted in the final product and certain textures cannot be achieved. The present invention has the rotating blade positioned in the top of the mixing container and the rotating blade moves up and down. Air is not introduced into the mixture because of the revolutionized designed so the intense flavors can be produced from the ingredients and high viscosity products also can be made in a short time period. In the present invention, the mixing container is also the serving container which results in an increased efficiency over the traditional blenders. Because of the fact that the same container is used for serving, the time which it takes to process any type of product is lowered significantly. Since the rotating blade is completely covered from the container, all of the rotating components in the present invention are hidden from the user. All of the hidden moving parts considerably improve the safety features of the present invention. The present invention eliminates waste, improves flavors, and offers a wide range of new ingredients and products not currently available.

### BRIEF DESCRIPTION OF THE DRAWINGS

FIG. 1 is a perspective view of the present invention.

FIG. 2 is a front view of the present invention.

FIG. 3 is a perspective view of the present invention.

FIG. 4 is a perspective view of the present invention showing a sectional view is taken from the FIG. 3.

FIG. 5 is a perspective view of a container used in the present invention.

FIG. 6 is a perspective view of a container holder in the present invention.

FIG. 7 is a perspective view of the container holder in the present invention.

FIG. 8 is a side view of the present invention.

FIG. 9 is a side cross sectional view of the present invention taken from the FIG. 8.

### DETAIL DESCRIPTIONS OF THE INVENTION

All illustrations of the drawings are for the purpose of describing selected versions of the present invention and are not intended to limit the scope of the present invention.

The present invention, a hermetic blender, is a food processing appliance which is mainly used in the commercial industry to blend drinks and soft serve products. The present invention has a fixed volume of material ensuring that the processing space is always full. If the container is half full the resulting space negates the effectiveness of the process. Redesigned blades also allow for a much wider choice of ingredients such as nuts, dried and freeze dried fruits and vegetables as well as hard fresh fruits and vegetables such as carrots, turnips, radishes, sweet potatoes, etc. or highly fibrous materials such as bell peppers, cabbage, and celery. Ordinary blenders do not process the ingredients to acceptable levels and leave chunky or stringy mixtures. The present invention is a high power, volume specific device designed to more efficiently process existing blended drink ingredients as well as allowing for a wider range of ingredients. The present invention comprises a hermetic blender station 1, a base platform 2, a cup 3 and a holder 4.

The hermetic blender station 1 comprises a motor 11, a blade housing 13, a control panel 14, a display panel 15, a plurality of container locks 16, and a cup seal 17. The motor 11 is positioned inside the hermetic blender station 1. The blade housing 13 comprises a telescopic blade shaft 131 and a blade 132. The blade housing 13 is designed into a circular shape therefore the telescopic blade shaft 131 and the blade 132 move without any obstruction from the blade housing 13. The blade housing 13 is made out of plastic. The blade 132 is connected to the telescopic blade shaft 131 from below and the telescopic blade shaft 131 is connected to the motor 11. In ordinary blenders, a low viscosity is required so the ingredients fall back into the rotating blade by gravity. Because of the low viscosity, the impact pressure of the rotating blade is also low. The blade 132 used in the present invention is similar to existing blender blades but the telescopic blade shaft 131 automatically moves top to bottom in up and down cycles. This particular movement is necessary to achieve mixtures of very high viscosities without compromising the texture. Because of the fact that the telescopic blade shaft 131 and the blade 132 rotate and move in a unique way, it is no longer necessary to keep the entire volume of mixture moving within the processing environment. The present invention does not require gravity to pull ingredients downward like the ordinary blenders; therefore, the final mixture is evenly broken into small pieces providing the required texture and uses a short amount of time compared to ordinary blenders. The above properties are achieved by trapping the ingredients inside the cup 3 which results in a dramatically increased impact pressure between the blade 132 and the ingredients. The telescopic blade shaft 131 and the blade 132 are made out of stainless steel. Stainless steel is used in the telescopic blade shaft 131 and the blade 132 in order to prevent corrosion and the stainless steel provides necessary strength needed for the telescopic blade shaft 131 and the blade 132.

The control panel 14 is connected to the hermetic blender station 1 and is positioned on the front surface of the hermetic blender station 1. The display panel 15 is connected to the hermetic blender station 1 above the control panel 14. The display panel 15 is electronically connected to the control panel 14. The display panel 15 displays different types of messages which depend on the functionality of the present invention. For an example, the display panel 15 could show a digital clock that keeps track of the time. The specific digital clock can be displayed through the display panel 15. The control panel 14 comprises a plurality of buttons which is assigned into different functionalities of the present invention and the plurality of buttons is distributed horizontally. Each of the buttons in the plurality of buttons can be assigned to different speeds, pre timed buttons, and different type of textures. The plurality of container locks 16 is positioned at the bottom of the blade housing 13 and the plurality of container locks 16 is designed into an “L” shape designed. The plurality of container locks 16 comprises at least two or more “L” shaped designed components. The plurality of container locks 16 is used as the locking mechanism for any type of container used in the present invention. The plurality of container locks 16 locks the holder 4 to the hermetic blender station 1 creating a firm fit. Since the cup 3 is locked into the hermetic blender station 1, the wastage of the ingredients is minimized. A chip may be connected to the holder 4 or the plurality of container locks 16. The main purpose of the chip is to calibrate the proper connection between the holder 4 and the hermetic blender station 1. The chip is electronically connected to the display panel 15 and control the blade 132 movement according to the cup size 3. For an example, if an incorrect container is used in the holder 4, due to the size difference, the chip displays an error message through the display panel 15. The chip also displays the same error message in the display panel 15, if the holder 4 is not properly attached or unbalance. The chip ensures the present invention ensures the safety of the user and at the same time eliminates any kind of accidents that might take place between the cup 3 and the blade 132.

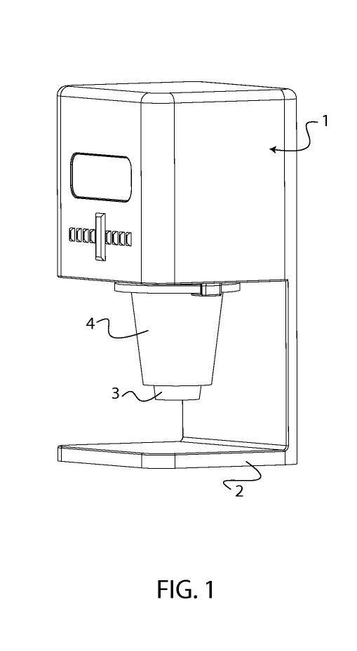

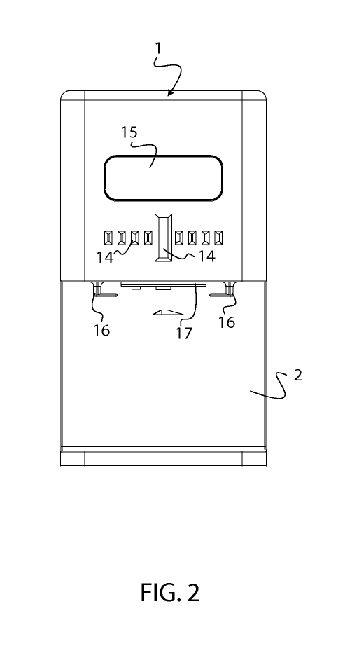

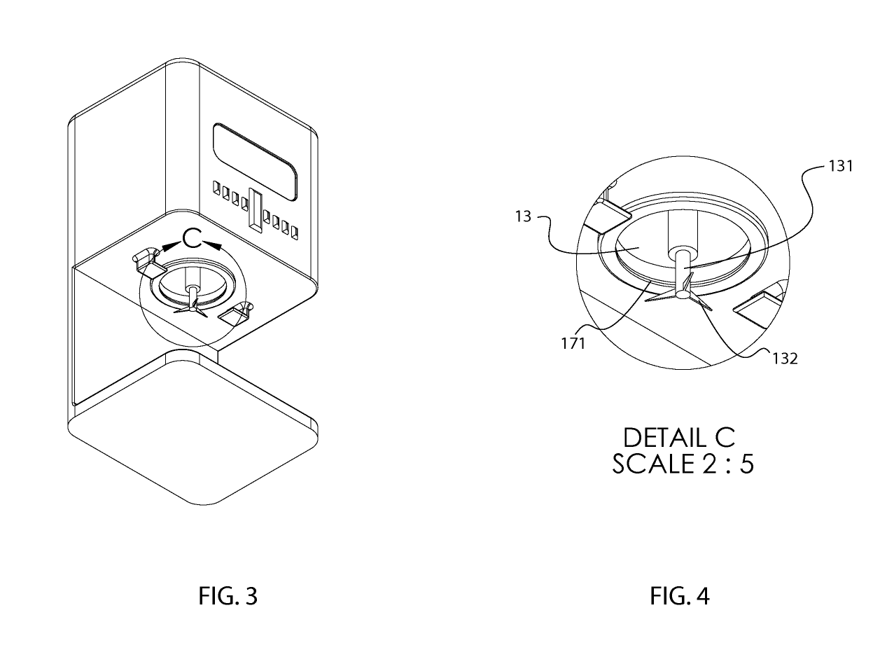

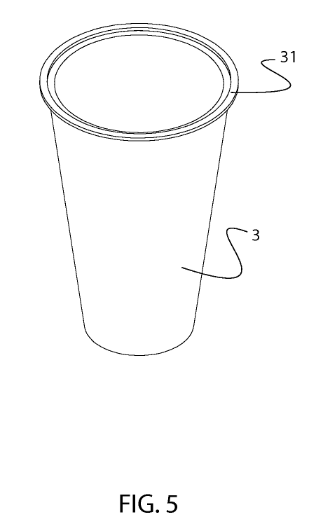

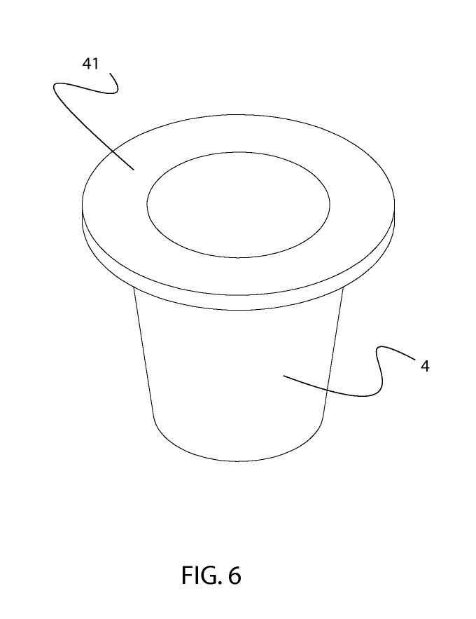

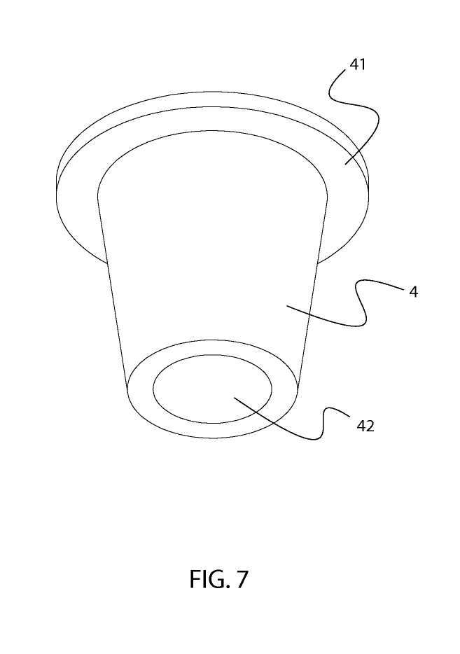

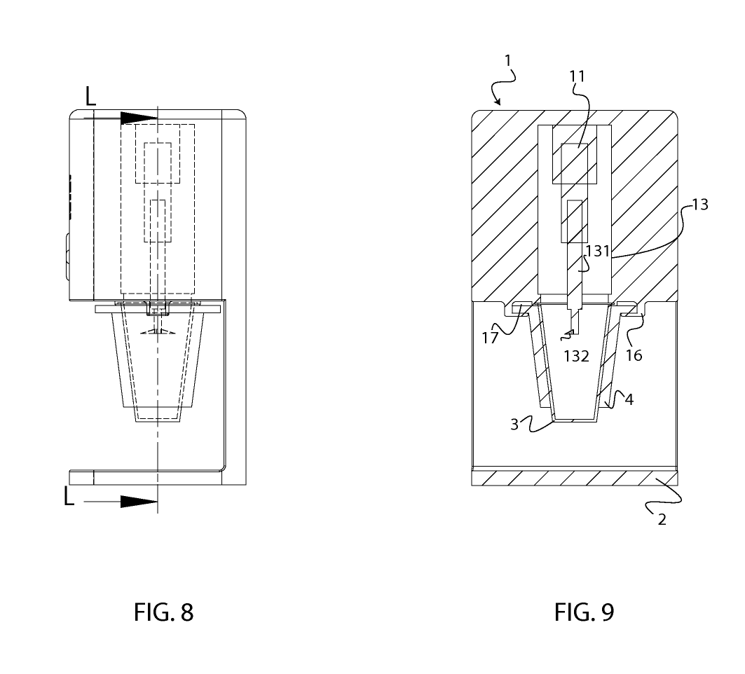

The base platform 2 is connected to the hermetic blender station 1. The base platform 2 keeps the present invention upright. In reference to FIG. 1, the base platform 2 may be designed into an “L” shape design in the present embodiment but the shape of the base platform 2 is not be limited only to the “L” shape designed. The base platform 2 can be made out materials which can sustain the weight of the hermetic blender station 1. Since the hermetic blender station 1 has a higher weight because of its components and configurations, the base platform 2 is designed to counterweight the hermetic blender station 1 so the present invention has well balanced structure. The base platform 2 of the present invention is made out of plastic, metal, or a combination of both.

The holder 4 comprises a holder rim 41 and a bottom opening 42. The holder rim 41 is positioned on the top of the holder 4 and extended outward. The bottom opening 42 is positioned at the bottom of the holder 4. Both holder rim 41 and bottom opening 42 have the circular shape design. The cup 3 is concentrically positioned inside the holder 4. The cup 3 comprises a cup rim 31. The cup rim 31 is positioned around the cup 3 and connected from the top. The size and shape of the cup 3 does not limit the present invention because the present invention can be modified into any size and shape of the cup 3. The height of the cup 3 is always larger than the height of the holder 4. Because of the height difference, the top half of the cup 3 isolates from the holder 4 and the users of the present invention can easily lift the cup 3 off from the holder 4. Users can hold the cup 3 from their fingers and simply lift the cup 3 up. The holder 4 is made out of plastic, metal, or a combination of both. The inside surface of the holder 4 has a circular shape design which resembles the shape of the cup 3. The outside surface of the cup 3 lays against the inside surface of the holder 4 upon the cup 3 being inserted. The cup rim 31 is placed on top of the holder rim 41 upon the cup 3 that is being inserted, giving a firm connection between the two components. Since the height of the cup 3 is larger than the holder 4, the bottom end of the cup 3 extends out from the bottom opening 42. Due to the unique design of the bottom opening 42 and the holder rim 41, the holder 4 slides off from the cup 3 when the cup 3 is placed on a table top. Since the holder rim 41 and the cup 3 have the same shape, the cup 3 doesn't deform during the ingredients being mixed together. The holder 4 is then raised up and locked in the hermetic blender station 1. The cup rim 31 connects to the cup seal 17 after the holder 4 has been raised up. The cup seal 17 comprises a cup slot 171. The cup rim 31 is inserted into the cup slot 171 connecting both components. The connection between the cup rim 31 and the cup slot 171 creates an air tight seal between the cup 3 and the blade housing 13. The cup seal 17 is made out of rubber because rubber can withstand constant movement of the inserting and removing of the cup 3 and is flexible enough so the cup 3 can be easily inserted into the cup slot 171.

Because of the air tight seal, the present invention processes food mixes without the presence of air. This is a key feature in the present invention because ordinary blenders and food processors always add air into the mixing of ingredients, causing a diluting effect to the flavor and changing the chemistry of the ingredients. When blending with existing machines, the rotating blade speed and viscosity of the material must be balanced in order to create the familiar whirlpool currently experienced. During this process air is infused into the material and the viscosity is limited in order to have the material fall back onto the rotating blade. The ingredients separation which can be seen in the ordinary blended drinks after some time is a common problem. The ingredients separation takes place because the ingredients are not mixed properly due to the addition of the air. Once the air bubbles release from the mixture, the separation process starts to take place. Since the present invention doesn't dilute the ingredients with air, the resulting mixture has an intense taste and the texture demonstrates significant improvements. Because of the fact that there is no air added during the mixing process, the separation of the ingredients does not take place and the same constant flavor can be achieved from start to finish. The hermetic process dramatically shortens the processing time of frozen materials and produces a much more homogenous or emulsified product. The exact same ingredients processed hermetically stay in suspension much longer than in ordinary blenders. This is because of the airless environment and higher impact pressures. The hermetic environment forces the materials to stay in contact with the blade 132 because there is no airspace available for the materials to move away from the blade 132.

Normal plastic cups can be used as the cups 3 in the present invention. There are many advantages due to the fact that normal plastic cups are being used. There is almost zero wastage because of the plastic cups. As for the ordinary blenders, the final mixture exchanges from a blender mixing container to a serving container. In the present invention, all of the ingredients that go into the cup 3 come out after the mixing process is finished. Therefore, users can simply remove the cup 3 from the hermetic blender station 1 and serve. This method allows the processing of products such as smoothies, shakes, margaritas, ice cream, frozen yogurt, sorbet, nut butter, pate, cheese spreads, soups, etc. to be served in the same container they are processed in. This eliminates waste of food product and at the same time allows for very specific viscosities to be obtained. Since the mixing container is the serving container, the process of serving a smoothie or milkshake is much faster in the commercialized industry. Consumers do not have to wait a long time to get their products and the whole process is highly efficient. For products that do not serve in the cup 3, the blending process is done in the cup 3 and then transferred into a specific serving container desired. Whenever the blade 132 needs to be cleaned, the cup 3 filled with water connects to the blade housing 13 and blends for a short time. Because of the above describe method of cleaning, the process of cleaning is highly efficient and cleans both the blade housing 13 and the cup seal 17.

Although the invention has been explained in relation to its preferred embodiment, it is to be understood that many other possible modifications and variations can be made without departing from the spirit and scope of the invention as hereinafter claimed.

What is claimed is:

1. A hermetic blender comprises,
a hermetic blender station;
a base platform;
a cup;
a holder;
the hermetic blender station comprises a motor, a blade housing, a control panel, a display panel, a plurality of container locks, and a cup seal;
the cup comprises a cup rim; and
the holder comprises a holder rim and bottom opening.

2. The hermetic blender station as claimed in claim 1 comprises,
the hermetic blender station being connected to the base platform;
the cup being inserted into the holder; and
the holder being inserted into the plurality of container locks.

3. The hermetic blender station as claimed in claim 2 comprises,
the motor being positioned inside the hermetic blender station;
the blade housing being centrically positioned in the hermetic blender station;
the control panel being connected to the hermetic blender station from outside;
the display panel being positioned above the control panel and connected to the hermetic blender station;
the plurality of container locks being positioned around the blade housing from below; and
the cup seal being connected to the blade housing from below.

4. The hermetic blender station as claimed in claim 3 comprises,
the blade housing comprises a telescopic blade shaft and a blade;
the telescopic blade being concentrically connected to the motor;
the blade being perpendicularly connected to the telescopic blade; and
the telescopic blade being positioned inside the blade housing.

5. The hermetic blender station as claimed in claim 3 comprises,
the motor being electronically connected to the control panel; and
the display panel being electronically connected to the control panel.

6. The hermetic blender station as claimed in claim 2 comprises,
the cup being inserted into the holder from top;
the cup being traversed through the holder rim and the bottom opening; and
the cup rim being positioned on the holder rim.

7. The hermetic blender station as claimed in claim 6 comprises,
The cup seal comprises a cup slot;
the cup being concentrically inserted into the blade housing;
the cup rim being positioned inside the cup slot;
the cup rim being attached to the cup slot.

8. A hermetic blender comprises,
a hermetic blender station;
a base platform;
a cup;
a holder;
the hermetic blender station comprises a motor, a blade housing, a control panel, a display panel, a plurality of container locks, and a cup seal;
the cup comprises a cup rim;
the holder comprises a holder rim and bottom opening;
the hermetic blender station being connected to the base platform;
the cup being inserted into the holder; and
the holder being inserted into the plurality of container locks.

9. The hermetic blender station as claimed in claim 8 comprises,
the motor being positioned inside the hermetic blender station;
the blade housing being centrically positioned in the hermetic blender station;
the control panel being connected to the hermetic blender station from outside;
the display panel being positioned above the control panel and connected to the hermetic blender station;
the plurality of container locks being positioned around the blade housing from below; and
the cup seal being connected to the blade housing from below.

10. The hermetic blender station as claimed in claim 9 comprises,
the blade housing comprises a telescopic blade shaft and a blade;
the telescopic blade being concentrically connected to the motor;
the blade being perpendicularly connected to the telescopic blade; and
the telescopic blade being positioned inside the blade housing.

11. The hermetic blender station as claimed in claim 9 comprises,
the motor being electronically connected to the control panel; and
the display panel being electronically connected to the control panel.

12. The hermetic blender station as claimed in claim 8 comprises,
the cup being inserted into the holder from top;
the cup being traversed through the holder rim and the bottom opening; and
the cup rim being positioned on the holder rim.

13. The hermetic blender station as claimed in claim 12 comprises,
The cup seal comprises a cup slot;
the cup being concentrically inserted into the blade housing;
the cup rim being positioned inside the cup slot; and
the cup rim being attached to the cup slot.

14. A hermetic blender comprises,
a hermetic blender station;
a base platform;
a cup;
a holder;
the hermetic blender station comprises a motor, a blade housing, a control panel, a display panel, a plurality of container locks, and a cup seal;
the cup comprises a cup rim;
the holder comprises a holder rim and bottom opening;
the hermetic blender station being connected to the base platform;
the cup being inserted into the holder;
the holder being inserted into the plurality of container locks;
the cup being inserted into the holder from top;
the cup being traversed through the holder rim and the bottom opening; and
the cup rim being positioned on the holder rim.

15. The hermetic blender station as claimed in claim 14 comprises,
the motor being positioned inside the hermetic blender station;
the blade housing being centrically positioned in the hermetic blender station;
the control panel being connected to the hermetic blender station from outside;
the display panel being positioned above the control panel and connected to the hermetic blender station;
the plurality of container locks being positioned around the blade housing from below; and
the cup seal being connected to the blade housing from below.

16. The hermetic blender station as claimed in claim 15 comprises,
the blade housing comprises a telescopic blade shaft and a blade;
the telescopic blade being concentrically connected to the motor;
the blade being perpendicularly connected to the telescopic blade; and
the telescopic blade being positioned inside the blade housing.

17. The hermetic blender station as claimed in claim 15 comprises,
the motor being electronically connected to the control panel; and
the display panel being electronically connected to the control panel.

18. The hermetic blender station as claimed in claim 14 comprises,
The cup seal comprises a cup slot;
the cup being concentrically inserted into the blade housing;
the cup rim being positioned inside the cup slot; and
the cup rim being attached to the cup slot.
